(19) United States
(12) Patent Application Publication
(10) Pub. No.: US 2026/0246156 A1
(43) Pub. Date: Aug. 20, 2026

(54) RADAR DECOY

(71) Applicant: BAE SYSTEMS plc, London (GB)

(72) Inventors: Jonathan PINTO, Chelmsford, Essex (GB); James Edwin GERARD, Chelmsford, Essex (GB)

(73) Assignee: BAE SYSTEMS plc, London (GB)

(21) Appl. No.: 19/489,499

(22) PCT Filed: May 31, 2024
(86) PCT No.: PCT/GB2024/051414

§ 371 Date: Dec. 2, 2025

(30) Foreign Application Priority Data
Jun. 2, 2023 (GB) 2308345.4

(51) Int. Cl. H01Q 15/18; H01Q 1/28; H01Q 3/46

(52) U.S. Cl. CPC H01Q 15/18; H01Q 1/28; H01Q 3/46

(57) ABSTRACT

The present disclosure relates to radar decoys, methods for controlling radar decoys and UAVs having a radar decoy. The radar decoy may comprise a passive reflector arranged to reflect radar signals, and a semi-active metasurface configured to have a reflection coefficient with a time-variable complex component. The present disclosure also relates to a method of controlling a semi-active radar metasurface.

### FIELD

The present disclosure relates to a radar decoy, to a method of controlling the radar decoy, to a UAV including the radar decoy, and to a method of controlling a semi-active metasurface.

### BACKGROUND

Modern warfare involves extensive use of air defence, such as ground based air defence (GBAD). A key aspect of GBAD is the ability to detect, identify, and track aircraft and missiles.

Identification of aircraft and missiles includes the determination of a type of aircraft or missile detected. By analysing characteristics of a radar return signal from an aircraft, it may be possible to determine a type and size of the aircraft detected.

For example, from a magnitude of the radar return signal, a radar cross-section (RCS) of the aircraft can be determined, which in turn can be used to determine a size of the aircraft.

Additionally, by analysing the spectral signature of the return signal, the type of aircraft can be determined. For rotorcraft (such as helicopters), the fuselage will give rise to a static radar return signal generally having a large RCS. Additionally, the rotating rotor blades will give rise to a return signal having a doppler characteristic. In particular, the rotation of the rotor blades towards and away from the radar receiver will give rise to respective positive and negative doppler shifts in the return signal. Moreover, because the linear speed of each rotor increases in proportion to distance from the rotor hub, a continuous spectrum of doppler shifts is present in the return signal. As a result of this doppler spectrum, the radar return signal from a rotorcraft is markedly different to a radar return signal from a fixed wing aircraft. Accordingly, many radar coherent systems are able to distinguish (amongst other things) between fixed wing aircraft and rotorcraft.

Many GBAD systems will include a battle management radar (BMR) system for providing an overall air picture and detecting nearby aircraft, and a tracking radar (sometimes referred to herein as active tracking radar, or engagement radar) for tracking the position of an aircraft once detected and providing a high-resolution picture with rapid updates on aircraft position. BMR systems are effective at detecting multiple aircraft, and at identifying types of aircraft. However, they are less effective for tracking specific aircraft position(s). Active tracking radars, on the other hand, are effective for tracking specific aircraft position(s). Active tracking radars are preferably turned off for the majority of the time, to avoid revealing their position. They may only be turned on for tracking purposes when the BMR detects the presence of a threatening aircraft. It is for this reason that they are sometimes called engagement radar.

BMR usually operates in the S-band (approximately 3 GHz, or approximately 10 cm). Engagement radar usually operates in the X-band (approximately 10 GHz, or approximately 3 cm).

In order to ensure that the active tracking radar is not turned on in the event of a false alarm, the BMR will be configured to identify the type of aircraft using the methodology described above. Accordingly, only if the aircraft is determined to be a threat, for example if the aircraft is determined to be an attack helicopter, will the active tracking radar be turned on.

It is desirable, therefore, to find means for ‘tricking’ a radar air defence system into thinking that a threatening aircraft is nearby, thereby forcing the active tracking radar to turn on and reveal its position.

### SUMMARY

According to a first aspect of the present disclosure, there is provided a radar decoy comprising: a passive reflector arranged to reflect radar signals; and a semi-active metasurface configured to have a reflection coefficient with a time-variable complex component. The time-variable complex component may be configured to modulate a radar signal reflected from the metasurface to mimic a doppler shift or spectrum of doppler shifts.

Accordingly, the radar decoy mimics the radio signature of a rotorcraft. In particular, the passive reflector mimics the static RCS from a fuselage, and the metasurface mimics the doppler shifted RCS from rotor blades.

Herein, a metasurface is defined as an artificial surface which is structured to modulate behaviours of electromagnetic waves. A radio metasurface is defined herein as a metasurface which is structured to modulate behaviours of electromagnetic waves in the radio spectrum (defined herein as electromagnetic waves with a frequency between 1 Hz and 3 THz). More specifically, the metasurface may be configured to operate in one or both of the S-band (wavelengths of approximately 10 cm) and the X-band (wavelengths of approximately 3 cm).

A semi-active radio metasurface is defined as a radio metasurface which is not configured to transmit electromagnetic radio signals, but which is configured to modify electromagnetic radio signals reflected therefrom in a time-varying manner. This is in contrast with an active metasurface, which would be a surface which is configured to transmit electromagnetic radio signals. It is also in contrast to a passive metasurface, which would be a metasurface which is configured to modify radio signals reflected therefrom, but in a static (i.e. not time-dependent) way.

Herein, a passive reflector is defined as a reflector which reflects radio signals therefrom, without modifying the reflected signal in a time-varying manner.

Without wishing to be bound by theory, it is noted here that a surface having a non-zero complex component to its reflection coefficient will impart a phase shift to an electromagnetic signal reflected therefrom. By providing a metasurface having a reflection coefficient with a time-varying complex component, the phase shift of the reflected electromagnetic signal will accordingly have a time-varying phase shift imparted thereto. By modulating the time-varying phase shift, the reflected signal can accordingly be caused to mimic the phase signature of a doppler shifted signal.

According to a second aspect of the present disclosure, there is provided an unmanned aerial vehicle (hereafter “UAV”) having a radar decoy according to the first aspect attached thereto.

Many comparatively inexpensive UAVs travel at speeds which reflect those of rotorcraft. By contrast, UAVs with speeds reflecting those of fixed wing aircraft may be comparatively expensive. In order to trick a radar system into turning on, without putting a high value aircraft at risk, it is therefore desirable to modify an inexpensive UAV (having a speed which reflects that of a rotorcraft) so that its radar signature also mimics that of a rotorcraft.

Beneficially, a UAV according to the second aspect may mimic the radio signature of a military rotorcraft (e.g. military transport or attack rotorcraft), mimic the speed of a military rotorcraft, and have a significantly lower value than a military rotorcraft. Accordingly, the UAV of the second aspect can be used to force active radar tracking to reveal its location, without sacrificing the safety of a high value rotorcraft.

According to a third aspect, there is provided a method of operating a radar decoy according to any preceding claim, the method comprising applying a time-varying negative bias voltage across the metasurface.

Optional features of the first, second and third aspects will now be described.

The metasurface may be mounted on a reflective surface of the passive reflector. The metasurface may be spaced from the reflective surface. The metasurface may be spaced from the reflective surface by a low loss spacer, for example a spacer having low dielectric loss in the radio spectrum. Low dielectric loss may be defined herein as the magnitude of the imaginary part of the material's complex permittivity being no more than 5% of the magnitude of the real part of the material's complex permittivity. The spacer may, for example, comprise a low-density insulating material, for example a foam material or an expended polymer. In an exemplary embodiment, the spacer may comprise polyurethane foam. A separation distance between the metasurface and the reflective surface may be equal to one quarter of a wavelength to be modulated by the metasurface. For example, where the wavelength to be modulated is 10 cm (S-band), the separation distance may be approximately 2.5 cm. Where the wavelength to be modulated is 3 cm (X-band), the separation distance may be 7.5 mm. In practice, the separation distance may be slightly smaller than 2.5 cm, or slightly smaller than 7.5 mm. The reason for this is that the wavelength of the radio waves will be slightly shorter in the spacer material than in free space. For example, the separation distance may be between 0.2λ₀ and 0.25λ₀ (where λ₀ is the free-space wavelength, with the specific value within this range being dependent on the properties of the spacer material used). This equates to an S-band separation distance of between 2 cm-2.5 cm, and an X-band separation distance of between 6 mm-7.5 mm.

2 cm-2.5 cm or between 6 mm-7.5 mm. However, as the reader will understand, where radio bands other than the S-band or X-band are to be targeted, the separation distance will be different.

The passive reflector may comprise one of a trihedral reflector, a Bruderhedral reflector, and a Luneburg lens.

The metasurface may comprise a plurality of discrete metallic patches. Each patch may be attached to at least one adjacent patch via a varactor diode. The plurality of metallic patches may comprise an array of metallic patches, for example a two-dimensional array of metallic patches. The patches may be electrically coupled to one another via the varactor diodes, such that a first side of the array is electrically coupled with a second side of the array. Each patch may be attached to each of its nearest neighbours by a respective varactor diode. The varactor diodes may be arranged with the same polarity as one another, e.g. such that a negative bias voltage applied across the metasurface will negatively bias all of the varactor diodes.

The patches may be of uniform shape. The patches may be of uniform size. The patches may be arranged in a square array, such that each patch is adjacent to four neighbour patches. Each patch may be square. The patches may have the same orientation as one another. That is, the adjacent edges of the patches may be arranged parallel to one another.

The periodicity of the array of patches may be equal to one half of a free-space wavelength to be modulated by the metasurface. That is to say, the distance from the midpoint of one patch, to the midpoint of an adjacent patch, may be equal to one half of a free-space wavelength to be modulated by the metasurface. Accordingly, where the wavelength to be modulated is 10 cm, the periodicity of the array may be 5 cm.

As explained above, the wavelength of the radio waves in the spacer material may be less than the free-space wavelength. Depending on the spacer material used, the wavelength in the spacer material may be between 0.8λ₀ and 1λ₀ (where λ₀ is the free-space wavelength). Accordingly, the periodicity of the patches may in practice be between 0.4λ₀ and 0.5λ₀. The specific value within this range will depend on the spacer material used.

The array of patches may be connected at the first side thereof to a first electrical contact, and at the second side thereof to a second electrical contact. The patches located along the first side of the array (e.g. each of the patches located along the first side) may be connected to the first electrical contact. The patches located at the second side of the array (e.g. each of the patches located along the second side) may be connected to the second electrical contact. The first electrical contact may comprise a first bus-bar. The second electrical contact may comprise a second bus-bar. Each contact or bus-bar may extend in a direction which is oriented at 45° with respect to the edges of the patches.

The radar decoy may further comprise a controller. The controller may be configured to apply a voltage across the metasurface. The voltage may be a negative bias voltage, in that it may negatively bias the varactor diodes. The voltage may be a sinusoidally varying voltage. For example, the voltage may sinusoidally vary between a first negative bias voltage and a second negative bias voltage which is larger in magnitude than the first negative bias voltage. In some examples, the voltage may sinusoidally vary between zero and a predetermined negative bias voltage.

Regarding the second aspect, the rotors of the UAV may be shrouded in a radar shielding material.

The metasurface may comprise a plurality of sub-metasurfaces. Each sub-metasurface may resemble the metasurface of the first aspect. That is to say, each sub-metasurface may comprise a plurality (e.g. 2D array) of metallic patches, connected to one another by varactor diodes, wherein each side of the array is connected to a respective bus-bar for applying a voltage thereto. The sub-metasurfaces may be identical to one another. They may be arranged side-by-side. The sub-metasurfaces may be electrically isolated from one another. Each sub-metasurface may be connected to a respective controller. For example, each controller may be connected to the bus-bars of its respective sub-metasurface. Each controller may be configured to apply a respective negative bias voltage to its respective sub-metasurface. Each controller may be configured to apply a time-varying negative bias voltage (e.g. a sinusoidal negative bias voltage) having a respective frequency to its respective sub-metasurface.

According to a fourth aspect of the present disclosure, there is provided a method of controlling a semi-active radar metasurface, the metasurface arranged to have a reflection coefficient with a time-variable complex component, the method comprising: applying a time-varying voltage across the metasurface, to thereby generate a time-variable complex component in the reflection coefficient which causes a radar signal reflected from the metasurface to mimic a doppler shift or a spectrum of doppler shifts.

The time-varying voltage may for example be selected to cause the radar signal reflected from the metasurface to mimic the doppler shift or spectrum of doppler shifts. As the reader will understand, the specific doppler shift or spectrum to be mimicked will depend on the type of rotorcraft to be mimicked. Accordingly, the time-varying voltage may be selected based on the type of rotorcraft to be mimicked.

The metasurface may comprise a plurality of metallic patches, wherein each patch is attached to at least one adjacent patch via a varactor diode, and wherein applying the time-varying voltage across the metasurface comprises applying the time-varying voltage across the plurality of patches.

The metasurface may have the same structure as described above in respect of the first aspect.

The time-varying voltage may comprise a sinusoidally varying voltage. The time-varying voltage may be a negative bias voltage. The negative bias voltage may negatively bias the varactor diodes. The frequency of the time-varying voltage may be controlled to mimic the characteristic doppler shift at the rotation frequency of a point on the target helicopter rotor.

### BRIEF DESCRIPTION OF THE FIGURES

Embodiments of the invention will now be described by way of example only with reference to the figures, in which:

FIG. 1 shows a helicopter and a radar system;

FIG. 2 shows a first example passive reflector according to the present disclosure; and

FIG. 3 shows a second example passive reflector according to the present disclosure;

FIG. 4 shows a third example passive reflector according to the present disclosure;

FIG. 5 schematically illustrates a first example metasurface according to the present disclosure;

FIG. 6 schematically illustrates a second example metasurface according to the present disclosure;

FIG. 7 shows a voltage signal for application across a metasurface according to the present disclosure;

FIG. 8 shows a radar decoy according to the present disclosure; and

FIG. 9 schematically illustrates a UAV having a radar decoy according to FIG. 8 attached thereto.

Like reference numerals are used for like components.

### DETAILED DESCRIPTION

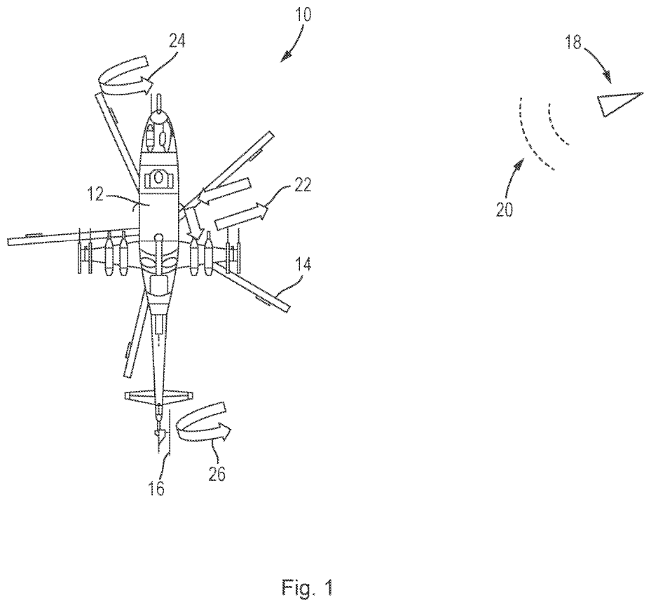

FIG. 1 shows a rotorcraft (in particular, a helicopter 10). The helicopter 10 has a fuselage 12, and a lift rotor 14. Lift rotor 14 in the example of FIG. 1 includes 5 rotor blades. The helicopter 10 also includes a tail rotor 16.

FIG. 1 also schematically illustrates a radar system 18, for example a monostatic radar system 10. Radar system 18 operates by transmitting an incident radar signal 20 towards the helicopter 10, and then detecting a radar return signal reflected from the helicopter 10. The radar return signal will include a static component 22 reflected from the fuselage 12, as described in more detail below. The radar return signal will also include a doppler shifted component 24 reflected from the lift rotor 14, also described in more detail below. The radar return signal may also include a secondary doppler shifted component 26 reflected from the tail rotor 18.

Herein, the present disclosure will be exemplified for radar signals in the 10 cm band (S-band), and for radar signals in the X-band (3 cm). However, as the reader will understand, different frequency ranges may be used by some radar systems, and so the specific dimensions, frequencies and wavelengths described herein represent just one exemplary arrangement and may be changed as required for a given context.

The present disclosure provides approaches for mimicking the radar signature of the static component, and/or for mimicking the doppler shifted component. Collectively, by mimicking the static component and the doppler shifted component, a radar signature which convincingly mimics that of the aircraft 10 can be achieved.

We will consider first the static component (i.e. mimicking of the signature from the fuselage 12). Aircraft fuselages provide static radar signatures. In particular, aircraft fuselages act as simple radar reflectors, and do not (in general) modulate radar signals reflected therefrom over the duration of a given radar pulse length or waveform. However, because aircraft fuselages are large reflective objects, they present a large radar cross-section (RCS). A challenge with mimicking an aircraft fuselage, therefore, is that of generating a large RCS. The fuselage of a medium-sized helicopter may have an RCS of between +15 and +20 dBsm.

According to the present disclosure, in order to mimic the fuselage 12, a passive reflector having a large RCS is used.

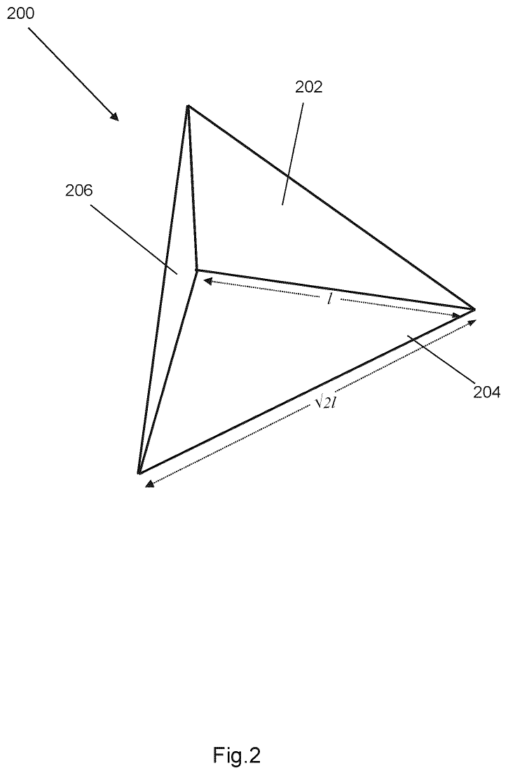

FIG. 2 shows a first example of such a passive reflector according to the present disclosure. The passive reflector in the first example is a triangular trihedral reflector 200. It comprises three mutually orthogonal reflective surfaces 202, 204, 206, for generating specular reflection. The peak RCS (σ) from a triangular trihedral reflector such as that shown in FIG. 2 is given by equation 1 below:

$$σ = \frac{4 π {\vert}^{4}}{3 {λ}^{2}} \qquad ( 1 )$$

where l is the length of each apex of the trihedral reflector; and where λ is the wavelength of the signal being reflected.

As shown in FIG. 2, where each apex of the trihedral reflector has a length of l, each leading edge of the trihedral reflector has a length of √2l. Each reflective surface 202, 204, 206 therefore comprises an isosceles triangle, with sides of length l, l, and √2l.

Accordingly, the apex length l (and, equivalently, the size of the trihedral reflector) can be selected to match the RCS to be mimicked. For mimicking a medium-sized helicopter in the 10 cm band, the triangular trihedral reflector may be provided having an apex length, l, of 60 cm, giving an RCS of +17.5 dBsm. As the reader will understand, the size of the reflector will be varied according to the radio band, and according to the size of the fuselage to be mimicked.

In other examples, a different corner reflector, for example a dihedral corner reflector, or a square trihedral reflector, or a circular trihedral reflector, may be used.

Each surface 202, 204, 206 is flat (planar). Each surface 202, 204, 206 of the reflector is a conductor, for example may have a conductive surface. The conductor may, for example, be copper. In some examples, a conductive mesh, as opposed to a solid conductive surface, may be used.

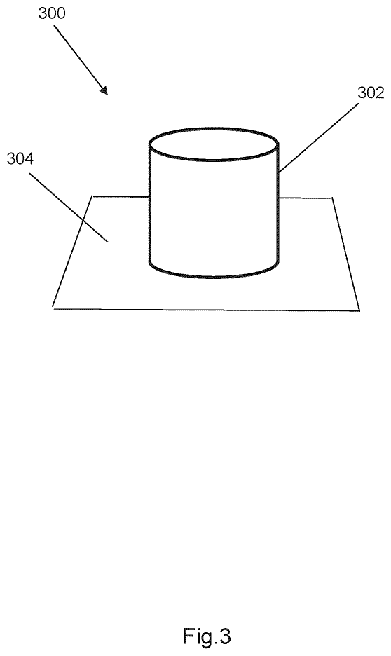

FIG. 3 shows a second example of a passive reflector 300 according to the present disclosure. The passive reflector 300 of the second example is a bruderhedral reflector, comprising in particular of a cylindrical reflector 302 mounted on a planar reflective sheet 304. Bruderhedral reflectors also produce specular reflection.

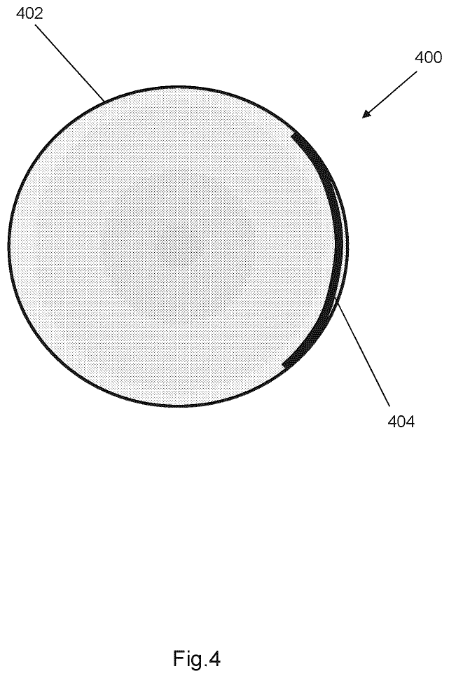

FIG. 4 shows a third example of a passive reflector 400 according to the present disclosure. The passive reflector 400 of the third example comprises a Luneburg lens 402, which characterized as a transmissive solid spherical object having a refractive index which decreases radially from a centre thereof. A reflective coating 404 is applied to a rear surface of the Luneburg lens 402. The passive reflector 400 of the third example also produces specular reflection.

As the reader will understand, a passive reflector according to FIG. 2, or according to FIG. 3, or according to FIG. 4, may be used as the passive reflector according to the present disclosure. However, because a trihedral has the largest RCS per unit size of the passive reflector, it may be preferred for many applications. In use, the passive reflector may be encased within a transparent radome, for aerodynamic improvement.

The mimicking of the doppler characteristics of the rotor 14 will now be described.

While a helicopter rotor is rotating, at any given point in time, at least one rotor will be travelling towards a given point in space (e.g. the location of a radar system), and at least one rotor will be travelling away from the given point. The rotor travelling towards the radar system will impart a positive doppler shift on the radar signal reflected from the rotor and returned to the radar system. The rotor travelling away from the radar system will impart a negative doppler shift on the radar signal reflected from the rotor and returned to the radar system. In addition, because the linear speed of each rotor blade increases with distance from the centre of the rotor, a spectrum of positive and negative doppler shifts is imparted on the radar return signal. Doppler shifting of this type is detectable as a characteristic phase signature in the radar return signal. The metasurface of the present disclosure, described in more detail below, is configured to replicate this characteristic phase shifting, thereby mimicking the doppler shifting.

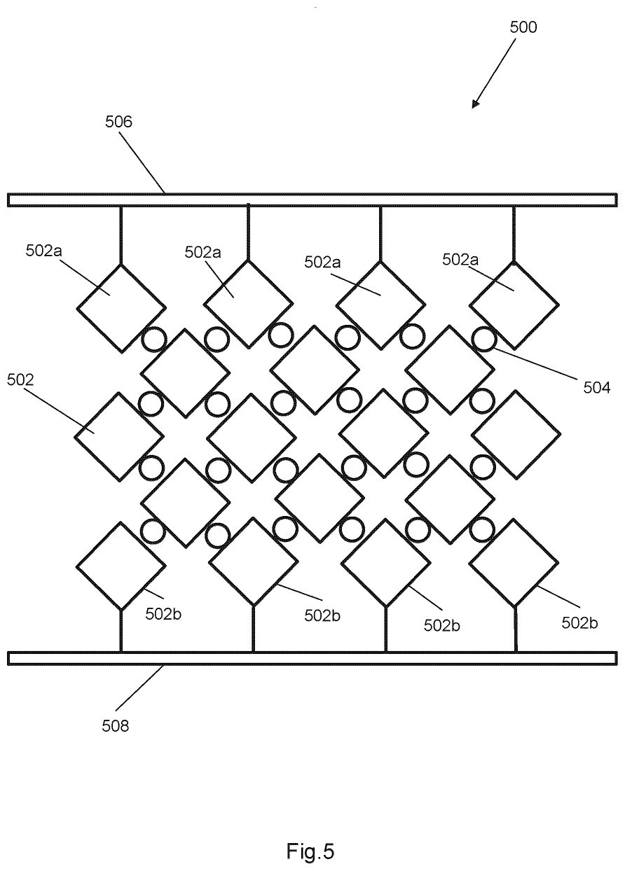

FIG. 5 shows a first example metasurface 500 according to the present disclosure.

The metasurface 500 of FIG. 5 comprises a plurality of square metallic patches 502, arranged in a square array. The patches may, for example, be copper. However, any metal having good conductivity may be used. Each metallic patch 502 is electrically connected to each of its neighbouring patches via a respective varactor diode 504. A varactor diode is a diode whose internal capacitance varies with respect to a reverse voltage applied thereto. That is, as the magnitude of a reverse voltage applied to a varactor diode is increased, the capacitance of the varactor diode decreases (due to an inverse proportionality between the magnitude of the reverse bias voltage and the capacitance). As shown, each varactor diode is connected at a midpoint of the edge of the patches 502 to which it is attached.

A first bus-bar 506 is located along a first edge of the array. A second bus-bar 508 is located along the second edge of the array. As shown, each bus-bar extends in a direction which forms an angle of 45° with respect to the edges of the patches. Accordingly, the array forms a diamond arrangement with respect to the bus-bars 506, 508. The patches 502a at the first edge of the array are electrically connected to the first bus-bar 506. The patches 502b at the second edge of the array are electrically connected to the second bus-bar 508. Accordingly, by applying a voltage across the first and second bus-bars 506, 508, a voltage is applied across the entire array, and across each of the varactor diodes.

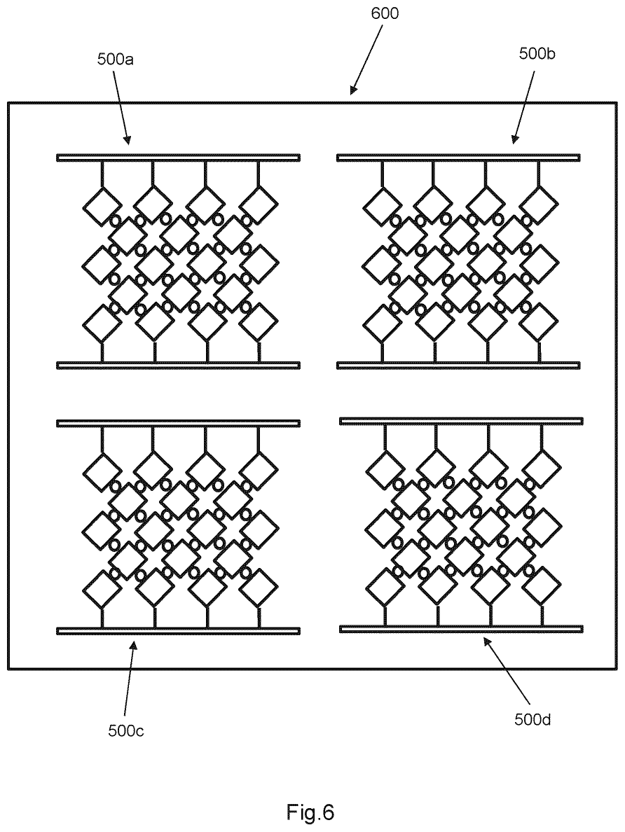

FIG. 6 shows a second example metasurface 600 according to the present disclosure. As shown, the metasurface 600 according to FIG. 6 comprises four sub-metasurfaces 500a, 500b, 500c, 500d, each of which has the exact same configuration as the metasurface 500 of FIG. 5. In particular, each sub-metasurface includes an array of patches 500, a corresponding plurality of varactor diodes 504, and two bus-bars 506, 508. More than four sub-metasurfaces, or fewer than four sub-metasurfaces, may be employed. Four are used in FIG. 6 for illustrative purposes. As will be described in more detail below, a different voltage signal may be applied to each of the sub-metasurfaces. FIGS. 5 and 6 are not drawn to scale. The patches of the FIG. 6 embodiment may be the same size as the patches of the FIG. 5 embodiment.

In each of the first example metasurface 500, and the second metasurface 600, the periodicity of the patches 502 in the or each array may be equal to approximately one half of the wavelength to be reflected and modulated.

The capacitance of each of the capacitors is inversely proportional to the magnitude of the negative voltage bias applied across the array. As the negative bias voltage is increased, the capacitance of the capacitors will decrease. As the negative bias voltage is decreased, the capacitance of the capacitors will increase. Without wishing to be bound by theory, because the complex component of impedance is dependent upon capacitance, varying the capacitance (by varying the negative bias voltage) will accordingly vary the complex component of the impedance of the metasurface.

Again without wishing to be bound by theory, it is further noted that a non-zero complex component of impedance in the metasurface (and equivalently a non-zero complex component of the metasurface's reflection coefficient) will cause a phase shift to be imparted to a signal reflected from the metasurface. As the complex component of the metasurface's reflection coefficient is varied (again, by varying the magnitude of the negative bias voltage applied across the array), the phase shift imparted on the reflected signal will similarly be varied. Accordingly, by appropriately controlling the negative bias voltage applied across the array, the phase of the return signal can be modulated to as to replicate the same spectral characteristics as are seen in a doppler shifted return signal, for example to replicate the doppler spectrum observed for a rotating rotor 14.

Metasurface 500 may be connected to a control unit (not shown). The control unit is configured to apply, across the metasurface, a negative bias voltage having the necessary signal characteristics for modulating a radar signal reflected from the metasurface to mimic a doppler shift.

Alternatively, each of the sub-metasurfaces 500a, 500b, 500c, 500d may be connected to a respective control unit (again, not shown). Each control unit is configured to apply, across its respective sub-metasurface, a respective negative bias voltage having the necessary signal characteristics for modulating a radar signal reflected from the metasurface to mimic a respective doppler shift. Collectively, the sub-metasurfaces 500a, 500b, 500c, 500d, when controlled by the respective control units, can therefore be controlled to approximate a full doppler spectrum.

Each sub-metasurface may be at least two wavelengths across, for example at least three wavelengths across (from edge-to-edge).

Control of the metasurfaces will be described in more detail below, starting with control of the metasurface 500 of FIG. 5.

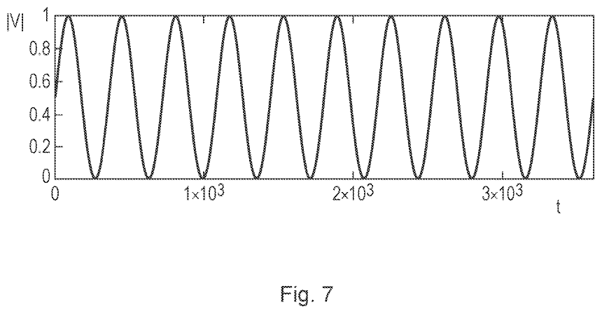

FIG. 7 shows a voltage signal applied across the bus-bars 506, 508 of the metasurface 500. The modulus of the normalized voltage (|V|) is on the y-axis. Time (t) in seconds is on the x-axis. The voltage signal is a sinusoidally varying negative bias voltage (defined as a voltage having a polarity which negatively biases the varactor diodes). The voltage varies sinusoidally between zero volts and a maximum negative bias voltage. The maximum negative bias voltage may, for example, be 30 v. However, as the skilled person will understand, the maximum negative bias usable will depend on the specific varactor diodes used.

The frequency of the voltage signal is controlled to mimic doppler shift at the characteristic rotation speed of the rotor 14 being mimicked. The frequency of the voltage signal may thus be selected to match the doppler frequency to be mimicked, which in turn will depend on the dynamics of the helicopter to be mimicked. As a rule of thumb, the driving frequency (Fd) of the voltage signal may be given by equation (i) below.

$$Fd = \frac{2 \cdot π \cdot Frot \cdot r}{Frad} , \qquad ( i )$$

where Frot is the rotation frequency of the helicopter blade, r is the radius of the helicopter blade, and Frad is the centre frequency the radar system to be deceived, for example the centre frequency of a given filter bank in the radar system.

When such a voltage signal is applied across the metamaterial 500, a radar return signal reflected from the metamaterial 500 will accordingly be modulated with a spectral characteristic which mimics a doppler shift which would be associated with the rotating rotor 14. Therefore, as the reader will understand, the frequency of the varying voltage signal will be selected based on the aircraft to be mimicked. Furthermore, the maximum amplitude of the varying voltage will be selected based on the aircraft to be mimicked.

Control of the metasurface 600 of FIG. 6 will now be described.

In order to more accurately reflect a full doppler spectrum which may be observed in a return signal from a rotor 14, each sub-metasurface 500a, 500b, 500c, 500d is supplied, by its respective control unit, with a sinusoidally varying reverse bias voltage, similarly to control of the metamaterial of FIG. 5. However, each sub-metasurface has a time-varying signal of a respective frequency applied across it, in order to mimic a full doppler spectrum, as opposed to a doppler shift at a given (single) frequency. In the FIG. 6 metasurface 600, up to four frequencies can be used. However, fewer than four frequencies could alternatively be used. In metasurfaces including more than four sub-metasurfaces, more than four frequencies can be used. The inventors have found that a handful of frequencies, for example three frequencies, or four frequencies, or five frequencies, may be sufficient to satisfactorily mimic the full doppler spectrum from a rotating rotor 14.

Where, for example, a radar system having four doppler filter banks is to be deceived, controlling the sub-metasurfaces by applying a corresponding four voltage signals (each having a frequency corresponding to a respective doppler filter bank of the radar system to be deceived) to the respective sub-metasurfaces, would give rise to a doppler return signal that is, at the resolution of the radar system, indistinguishable from a genuine return signal from a rotating rotor 14. In some radar systems, more doppler filter banks, for example eight doppler filter banks, may be used. To deceive such systems, eight sub-metasurfaces may be used, and each may have a voltage having a respective frequency applied thereto.

An aircraft to be mimicked may have a rotor diameter of 17.3 m, and a blade length of 8 m. The peak RCS of a single metallic blade is given by equation 2, below.

$${σ}_{blade} = {kaL}^{2} \qquad ( 2 )$$

where k is 2π/λ, λ is the wavelength of the incident signal to be reflected, a is the radius of curvature, and L is the blade length.

Assuming blades with a leading edge having a cylindrical cross-section with a radius of 1 cm, the RCS of the blade will be +16 dBsm.

The size of the metasurface required to replicate this RCS is then given by equation 3 below.

$${I}_{m}^{2} = \frac{{σ}_{blade} {λ}^{2}}{4 π} \qquad ( 3 )$$

where Iₘ is the length of one side of the square metasurface (e.g. the length of one side of the metasurface 500, of the length of one side of the metasurface 600).

Accordingly, to mimic the RCS of the rotor described above, a square metasurface having a side length of 18 cm would be required. As the reader will understand, the size will be selected based on the helicopter to be mimicked.

Helicopter blades in general rotate at a speed of between 225-400 rpm. The longer the blades, the lower the rotation rate, other factors being equal. Assuming a rotation speed of 300 rpm, we have a rotation frequency, f of 5 Hz (5 revolutions per second). This corresponds to an angular frequency, ω of 31.4 radians per second (where ω=2πf). The blade tips (which are 17.3 m/2=8.65 m from the centre of the rotor) this have instantaneous linear velocities of 272 m/s.

Supposing that a helicopter is hovering (i.e. flying but stationary), and is illuminated by a radar system having a pulse repetition interval of 750 Hz, it is possible to estimate the doppler frequency of the blade tips. Between successive pulses (separated by Δt=1/750=1.33 ms), the blade tip will have travelled a distance of 0.36 m. At a radar frequency of 3 GHz (λ=0.1 m), this is equivalent to 0.36/0.1=3.6λ. The doppler frequency is the number of cycles of the wavelength per second, and in this case is n/Δt=2.73 kHz. The sub-metasurfaces would therefore need to be driven with time-varying voltages having a frequency bandwidth of 5.46 kHz (to account for the positive and negative doppler shifts of opposing blades). That is, the frequencies supplied to the respective sub-metasurfaces would need to be selected to cover a total frequency bandwidth of 5.46 kHz. Phrased another way, the smallest frequency used may be approximately 5.46 kHz lower than the highest frequency used. As the reader will understand, this is a specific example, which would be selected based on the specific context (e.g. the properties of the helicopter to be mimicked and the radar frequency to be deceived).

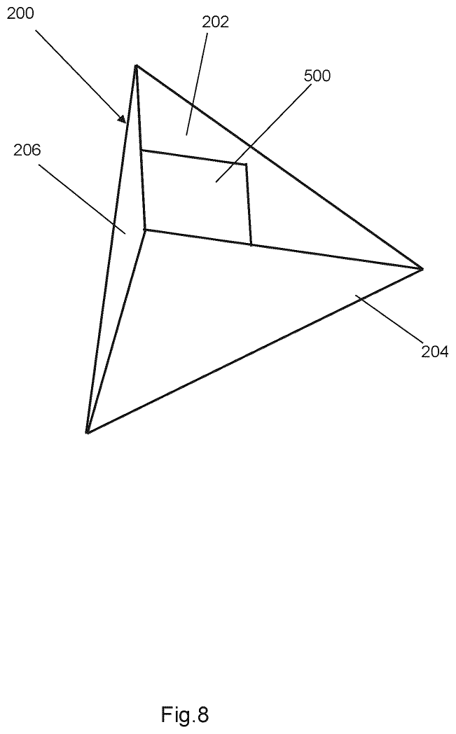

FIG. 8 shows a radar decoy 800 according to the present disclosure. The radar decoy 800 comprises the trihedral reflector 200 of FIG. 2, which the metasurface 500 of FIG. 5 affixed to a reflective surface thereof. In an alternative embodiment, the metasurface 600 of FIG. 6 could alternatively be affixed to the trihedral reflector 200. In alternative embodiments, the metasurface 500/600 may alternatively be attached to the Bruderhedral reflector of FIG. 3, or the Luneburg lens of FIG. 4.

The metasurface 500 is attached to the reflective surface of the trihedral reflector 200 of FIG. 2 with a low dielectric loss material (not shown) therebetween. That is, a low dielectric loss material is sandwiched between the reflective surface 202 of the trihedral reflector and the metasurface 500. The thickness of the low dielectric low material is equal to one quarter of the wavelength to be reflected.

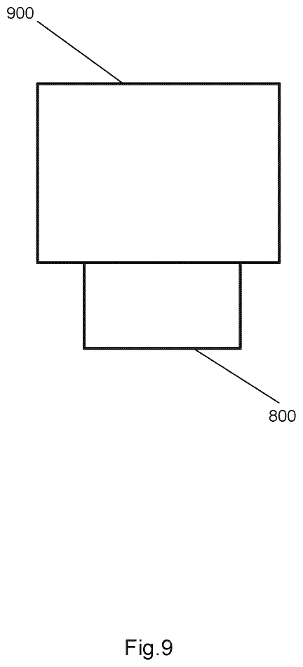

FIG. 9 schematically illustrates a UAV 900 with a radar decoy 800 according to FIG. 8 attached thereto. The radar decoy is attached to an underside of the UAV 900, but may in some examples be mounted on top of the UAV 900. The radar decoy 800 may be housed in a polystyrene fairing, e.g. a transparent polystyrene radome, for aerodynamic efficiency.

The above detailed description is intended to be illustrative, and not restrictive. Many other implementations will be apparent to those skilled in the art upon reading and understanding the above detailed description. Although the present disclosure has been described with reference to limited specific example implementations, it will be recognised that the disclosure is not limited to the implementations described, but can be practiced with modification and alteration insofar as such modification(s) and alteration(s) remain within the scope of the appended claims. The scope of the disclosure should, therefore, be determined with reference to the appended claims, along with the full scope of equivalents to which such claims are entitled.

1. A radar decoy comprising:
a passive reflector arranged to reflect radar signals; and
a semi-active metasurface configured to have a reflection coefficient with a time-variable complex component.

2. The radar decoy of claim 1, wherein the time-variable complex component is configured to modulate a radar signal reflected from the metasurface to mimic a doppler shift.

3. The radar decoy according to claim 1, wherein the metasurface is mounted on a reflective surface of the passive reflector.

4. The radar decoy according to claim 1, wherein the passive reflector comprises one of a trihedral reflector, a Bruderhedral reflector, and a Luneburg lens.

5. The radar decoy according to claim 1, wherein the metasurface comprises a plurality of discrete metallic patches, wherein each patch is attached to at least one adjacent patch via a varactor diode.

6. The radar decoy according to claim 5, wherein the patches are arranged in a square array such that each patch is adjacent to four neighbour patches.

7. The radar decoy according to claim 6, wherein the periodicity the patches is equal to one half of a wavelength to be modulated.

8. The radar decoy according to claim 6, wherein each patch is attached to each of its neighbour patches via a respective varactor diode.

9. The radar decoy according to claim 5, wherein the patches are connected at the first side thereof to a first electrical contact, and at the second side thereof to a second electrical contact.

10. The radar decoy according to claim 9, wherein each electrical contact comprises a respective bus-bar, wherein the patches along the first side are electrically connected to first bus-bar, and the patches along the second side are electrically connected to second bus-bar.

11. The radar decoy according to claim 1, further comprising a controller configured to apply a voltage across the metasurface.

12. The radar decoy of claim 11,
wherein the metasurface comprises a plurality of discrete metallic patches, wherein each patch is attached to at least one adjacent patch via a varactor diode,
wherein each patch is attached to each of its neighbour patches via a respective varactor diode, and
wherein the controller is configured to negatively bias the varactor diodes with a sinusoidally varying voltage.

13. The radar decoy of claim 10, wherein each bus-bar is oriented at 45° with respect to the edges of the patches.

14. The radar decoy of claim 3, wherein the metasurface is spaced from the reflecting surface to which it is mounted by a distance equal to one quarter of a wavelength to be modulated.

15. A UAV having a radar decoy according to claim 1 attached thereto.

16. The UAV of claim 15, wherein propellers of the UAV are shrouded in a radar shielding material.

17. A method of operating a radar decoy according to claim 1, the method comprising applying a time-varying negative bias voltage across the metasurface.

18. A method of operating a radar decoy according to claim 12, the method comprising applying a time-varying negative bias voltage across the metasurface, wherein the time-varying negative bias voltage negatively biases the varactor diodes.

19. The method of claim 18, wherein the time-varying negative bias voltage comprises a sinusoidally varying voltage.

20. A method of controlling a semi-active radar metasurface, the metasurface arranged to have a reflection coefficient with a time-variable complex component, the method comprising:
applying a time-varying voltage across the metasurface, to thereby generate a time-variable complex component in the reflection coefficient which causes a radar signal reflected from the metasurface to mimic a doppler shift.

21. The method of claim 20, wherein the metasurface comprises a plurality of metallic patches, wherein each patch is attached to at least one adjacent patch via a varactor diode, and wherein applying the time-varying voltage across the metasurface comprises applying the time-varying voltage across the plurality of patches.
